(19) United States
(12) Patent Application Publication
(10) Pub. No.: US 2016/0121852 A1
(43) Pub. Date: May 5, 2016

(54) DEFROSTER STRUCTURE FOR VEHICLE

(71) Applicants: DAIKYONISHIKAWA CORPORATION, Hiroshima (JP); MAZDA MOTOR CORPORATION, Hiroshima (JP)

(72) Inventors: Toshiteru YOSHIMURA, Aki-gun (JP); Masato SADANO, Hiroshima-shi (JP); Masao TANIMOTO, Kure-shi (JP)

(73) Assignees: MAZDA MOTOR CORPORATION, Hiroshima (JP); DAIKYONISHIKAWA CORPORATION, Hiroshima (JP)

(21) Appl. No.: 14/920,416

(22) Filed: Oct. 22, 2015

(30) Foreign Application Priority Data
Oct. 31, 2014 (JP) 2014-222797

(51) Int. Cl. B60S 1/02; B60S 1/54

(52) U.S. Cl. CPC B60S 1/023; B60S 1/544

(57) ABSTRACT

A defroster structure for a vehicle includes a duct guiding conditioned air sent out of an air conditioning unit to an outlet. The outlet is provided at a center of an upper surface of an instrument panel in a vehicle width direction along a lower end of a windshield. The duct includes an upstream portion, a downstream portion, and a curved portion curved and connecting the upstream and downstream portions together. An air passage in the duct has a partition dividing the air passage in a vehicle longitudinal direction into central and side air supply passages, which distribute air to a center and right and left sides of the windshield in the vehicle width direction. The partition extends from a point upstream of the curved portion of the duct to the downstream portion.

### CROSS-REFERENCE TO RELATED APPLICATION

This application claims priority to Japanese Patent Application No. 2014-222797 filed on Oct. 31, 2014, the entire disclosure of which is hereby incorporated by reference.

### BACKGROUND

The present disclosure relates to a defroster structure for a vehicle including a duct that is connected to an air conditioning unit and that guides conditioned air, sent out of this air conditioning unit, to an outlet provided through the upper surface of an instrument panel.

A general onboard air conditioning system includes an air conditioning unit, a duct, and a damper. The air conditioning unit is arranged in an instrument panel provided at the front of a vehicle cabin and extending in the vehicle width direction. The duct is connected to the air conditioning unit. The damper switches air passages in this duct. A heater and an evaporator for the air conditioning unit control the temperature of air, which is guided by the duct to an outlet and blown out into the cabin through the outlet.

The outlet includes a plurality of ventilation outlets, a foot air outlet, a rear air outlet, and a defroster outlet. The ventilation outlets are provided on both the right and left sides and at the center of the front surface (i.e., the surface facing the rear of the vehicle) of the instrument panel in order to blow out conditioned air toward occupants. The foot air outlet is provided under the instrument panel, and blows out conditioned air toward occupants' feet. The rear air outlet blows out conditioned air toward occupants on rear seats. The defroster outlet is provided through the upper surface of the instrument panel along the lower end of the windshield, and blows out conditioned air toward the windshield. In general, the defroster outlet is provided at the front of the upper surface of an instrument panel and extends widely in the vehicle width direction. A defroster duct communicates to the defroster outlet, and extends from the air conditioning unit toward the windshield. Conditioned air passing through the defroster duct and blown out of the defroster outlet reduces condensation of the windshield to ensure a sufficiently wide field of view for the driver.

Japanese Unexamined Patent Publication No. 2007-331743 discloses, as shown in FIG. 12, a structure guiding conditioned air sent out of the air conditioning unit 150 to defroster outlets 110, which are provided at the front of the upper surface of an the instrument panel 101, via defroster ducts 111. The defroster outlets 110 extend from the center to both the right and left sides of the instrument panel 101 in the vehicle width direction (in front of the driver's and front occupant's seats). Specifically, in this structure, while the defroster outlets 110 being outlets of the defroster ducts 111 are wide in the vehicle width direction, junctions with the air conditioning unit 150 being inlets are narrow. In addition, in this structure, an air passage 170 in each defroster duct 111 includes deflecting members 116 that guide conditioned air to both the right and left ends of a windshield 102.

In recent years, in order to promote safety during driving, vehicles with a head up display (HUD) device are already available as commercial products. The HUD displays, on the windshield, information on the speed and/or information of a car navigation system, and allows the driver to confirm such information without moving his or her line of sight. This HUD device includes a projector projecting such information onto the windshield. In some cases, such a projector is provided on one side of the upper surface of an instrument panel (i.e., in front of the driver's seat). In this case, defroster outlets cannot extend, as in the patent document cited above, widely enough to reach both the right and left sides of the upper surface of the instrument panel. It becomes thus difficult to distribute air to both the right and left ends of the windshield, in particular, to the lower end corners of the windshield.

To address this problem, as shown in FIG. 13, Japanese Unexamined Patent Publication No. 2006-88765 discloses a defroster duct 211 with a V-shaped partition 215 to diffuse conditioned air in the vehicle width direction. The conditioned air, which has passed through the defroster duct 211, is blown out upright through a central outlet 271, which is one of the divided outlets, and is blown sideward thorough the right and left outlets 272. This configuration could distribute air to both the right and left ends of the windshield, even if defroster outlets 271 and 272 are provided in a limited range surrounding the center of the upper surface of an instrument panel.

### SUMMARY

However, Japanese Unexamined Patent Publication No. 2006-88765 fails to disclose any specific structure to direct conditioned air sideward. Thus, the conditioned air would be once blown out upright from the right and left outlets separated by the V-shaped partition. Even if any structure could guide the conditioned air sideward, a rapid directional change might reduce the flow velocity to the point that only an insufficient quantity of air is distributed to both the right and left sides of the windshield, in particular, to the lower end corners thereof.

The problem described above occurs not only where the projector of the HUD is provided on one side of the upper surface of the instrument panel, but also where the installation states of various devices in an instrument panel hinders broad distribution of the defroster outlets at the front of the upper surface of an instrument panel.

It is an object of the present disclosure to provide a defroster structure for a vehicle, which greatly reduces condensation over the entire windshield by sending a sufficient quantity of conditioned air from an air conditioning unit to both the right and left ends of the windshield, when the conditioned air is guided to an outlet provided at the center of the upper surface of an instrument panel in the vehicle width direction.

In order to achieve the foregoing and other objects, the present disclosure provides the following defroster structure for a vehicle.

The defroster structure includes a duct connected to an air conditioning unit, and guiding conditioned air sent out of the air conditioning unit to an outlet. The outlet is provided at a center of an upper surface of an instrument panel in a vehicle width direction along a lower end of a windshield. The duct includes an upstream portion located closer to the air conditioning unit, a downstream portion located closer to the outlet, and a curved portion curved and connecting the upstream and downstream portions together. An air passage in the duct has a partition dividing the air passage in a vehicle longitudinal direction into a central air supply passage and a side air supply passage. The central air supply passage distributes air to a center of the windshield in the vehicle width direction. The side air supply passage distributes air to right and left sides of the windshield in the vehicle width direction. The partition extends from a point upstream of the curved portion of the duct to the downstream portion.

In this structure, the conditioned air, which has passed through the central air supply passage, is blown out toward the center of the windshield in the vehicle width direction. On the other hand, the conditioned air, which has passed through the side air supply passage, is blown out toward both the sides (both the right and left sides) of the windshield in the vehicle width direction. By providing, for example, a directing member for the side air supply passage, the directing member guides the conditioned air, passing through the side air supply passage, to both the right and left ends of the windshield. This allows for distribution of air over the entire windshield in the vehicle width direction.

In particular, since the partition is provided from a point upstream of the curved portion of the duct, the conditioned air introduced to the duct is distributed, in a rectified state, to the central and side air supply passages before being disturbed by the curved portion. As a result, a required quantity of conditioned air is readily taken into the side air supply passage.

The conditioned air taken into the side air supply passage passes through the curved portion, and is directed reliably by the directing member, for example, in a predetermined air blowing direction, through the downstream portion before reaching the outlet. This allows for supplying a sufficient quantity of conditioned air to both the right and left ends of the windshield, thereby preventing or reducing condensation over the entire windshield.

In the defroster structure for a vehicle, at a duct upstream end of the partition, the side air supply passage preferably has a larger cross-sectional area than the central air supply passage.

This structure increases the quantity of air supplied from the side air supply passage to both the right and left sides of the windshield. A sufficient quantity of conditioned air is then supplied to both the right and left ends of the windshield. As a result, the advantage of preventing or reducing condensation over the entire windshield is achieved more reliably.

At the duct upstream end of the partition, if the side air supply passage has a larger cross-sectional area than the central air supply passage, the cross-sectional area of the side air supply passage preferably decreases from the upstream portion of the duct to the curved portion thereof.

In this structure, since the cross-sectional area of the side air supply passage decreases from the upstream portion to the curved portion, the flow velocity of the conditioned air increases from the upstream portion to the curved portion of the duct. As a result, the conditioned air is more effectively directed toward both the right and left sides of the windshield at the downstream portion of the duct.

In the defroster structure for a vehicle, the side air supply passage is preferably adjacent to a portion of an inner surface of the duct facing a portion of the air conditioning unit sending conditioned air to the duct in an air sending direction.

In this structure, the quantity of the conditioned air sent out of the air conditioning unit, which enters the side air supply passage, is larger than the quantity of air entering the central air supply passage. This increases the quantity of air supplied through the side air supply passage to both the right and left side of the windshield. As a result, the advantage described above is achieved even more reliably.

In the defroster structure for a vehicle, the side air supply passage is preferably provided on an inner curved side of the curved portion of the duct.

In this structure, the partition prevents or reduces an excessive quantity of the conditioned air from flowing along the outer curved side of the curved portion of the duct.

This ensures a sufficient quantity of air supplied from the side air supply passage to both the right and left sides of the windshield. As a result, the advantage described above is achieved even more reliably.

In the defroster structure for a vehicle, the central air supply passage is preferably provided closer to a front of the vehicle, and the side air supply passage is preferably provided closer to a rear of the vehicle.

In this structure, the conditioned air blown out after having passed through the central air supply passage, and the conditioned air blown out after having passed through the side air supply passage do not interfere with each other. As a result, the advantage described above is achieved even more reliably.

In the defroster structure for a vehicle, a size of the side air supply passage as measured in the vehicle width direction preferably increases from upstream to downstream in the duct. The side air supply passage preferably includes a directing member directing conditioned air such that a larger quantity of air passes through the side air supply passage and is blown out of the outlet on right and left sides than at a center of the outlet in the vehicle width direction.

In this structure, the conditioned air, which has passed through the side air supply passage, is directed by the directing member toward a predetermined air blowing direction. The conditioned air abuts on the windshield at a predetermined angle, while being distributed to both the right and left sides of the windshield. In particular, the directing member is provided such that a larger quantity of air is blown out of the outlet on both the right and left sides of the outlet than at the center of the outlet in the vehicle width direction. As a result, the advantage described above is achieved even more reliably.

The directing member preferably divides the side air supply passage into a plurality of sub-air passages.

In this structure, the directing member improves the directivity of the conditioned air. As a result, the advantage described above is achieved even more reliably.

Each of the sub-air passages preferably has a larger cross-sectional area at an upstream end thereof than at a downstream end thereof.

This structure increases the cross-sectional area at the upstream end of each sub-air passage to introduce a sufficient quantity of conditioned air to the sub-air passage, and to increase the flow velocity of the conditioned air passing through the sub-air passages. As a result, the advantage described above is achieved even more reliably.

In the defroster structure for a vehicle, the side air supply passage preferably includes, as the directing member, a first deflecting rib, and a second deflecting rib located outside the first deflecting rib in the vehicle width direction. A duct downstream end of the first deflecting rib is preferably located outside a duct upstream end of the second deflecting rib in the vehicle width direction.

In this structure, the first deflecting rib is deflected such that its downstream end is located outside the upstream end of the second deflecting rib in the vehicle width direction. The first and second deflecting ribs improve the directivity of the conditioned air. As a result, the advantage described above is achieved even more reliably.

In the defroster structure for a vehicle, the side air supply passage preferably includes an air blowing direction restricting member at a downstream end thereof. The air blowing direction restricting member reduces a quantity of conditioned air passing through the side air supply passage and blown out from a center of the outlet in the vehicle width direction.

In this structure, the air blowing direction restricting member decreases the quantity of conditioned air blown out from the center of the outlet in the vehicle width direction, and increases the quantity of conditioned air blown out from both the right and left sides of the outlet in the vehicle width direction. As a result, the advantage described above is achieved even more reliably.

A predetermined device may be provided above the air blowing direction restricting member.

This structure allows for efficient utilization of the space above the air blowing direction restricting member in the side air supply passage, through which no conditioned air flows.

### BRIEF DESCRIPTION OF THE DRAWINGS

FIG. 1 is a top view of an instrument panel of a vehicle having a defroster structure according to an illustrative embodiment.

FIG. 2 is a partial enlarged view of FIG. 1 and illustrates a defroster outlet and surroundings of the instrument panel shown in FIG. 1.

FIG. 3 is a cross-sectional view of a vehicle's instrument panel and surroundings taken along the length of the vehicle.

FIG. 4 is a cross-sectional view taken along the plane A-A of FIG. 2, as well as a partial enlarged view of FIG. 3.

FIG. 5 is a cross-sectional view taken along the plane B-B of FIG. 2.

FIG. 6 is a perspective view illustrating a defroster duct of the defroster structure.

FIG. 7 is an exploded perspective view of the defroster duct.

FIG. 8 is a top view of the defroster duct.

FIG. 9 is a view of a partition in the defroster duct as seen from the rear of a vehicle.

FIG. 10 is a partial enlarged view of FIG. 9 and illustrates the degree of deflection of a deflecting rib.

FIG. 11 is a schematic top view schematically illustrating a defroster outlet of a defroster duct according to a variation of the illustrative embodiment.

FIG. 12 illustrates a conventional defroster structure.

FIG. 13 illustrates another conventional defroster structure.

### DETAILED DESCRIPTION

Illustrative embodiments will now be described with reference to the drawings.

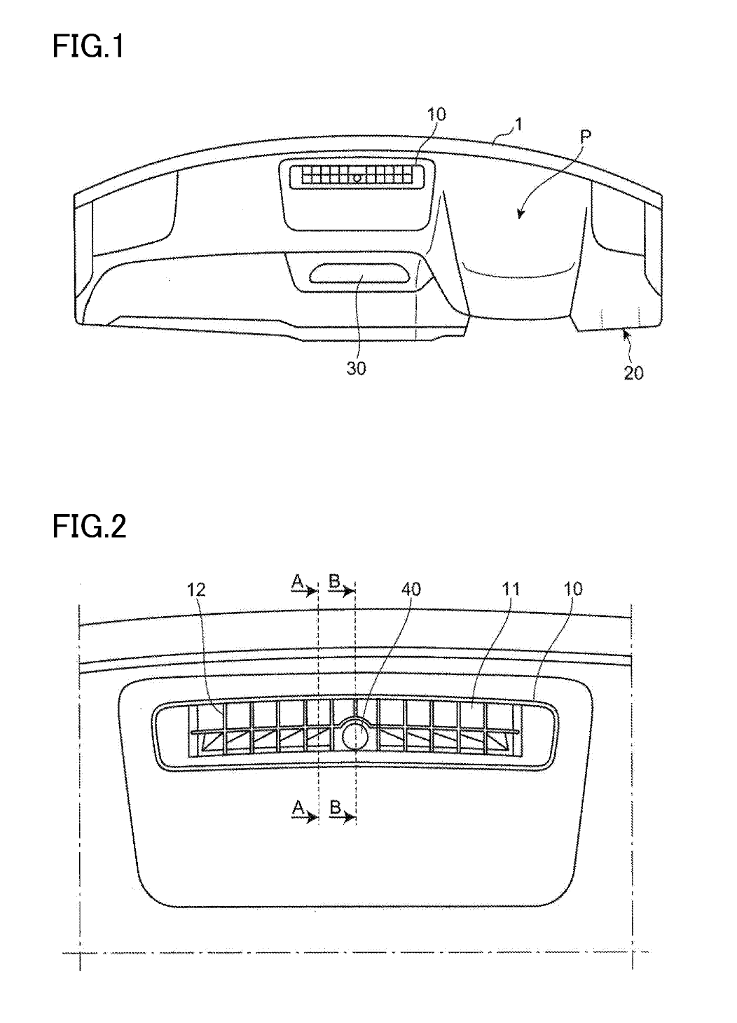

FIG. 1 is a top view of an instrument panel 1 of a vehicle having a defroster structure according to an illustrative embodiment.

The instrument panel 1 is provided at the front of a vehicle cabin, and extends in the vehicle width direction. A defroster outlet 10, which corresponds to an outlet, is provided at a center of the upper surface of the instrument panel 1 in the vehicle width direction so as to extend in the vehicle width direction along the lower end of the windshield 2. A ventilation outlet 20 is provided through a front surface of the instrument panel 1, which faces the rear of the vehicle, at each side end (i.e., each of the right and left sides) in the vehicle width direction. The ventilation outlet 20 blows out conditioned air toward occupants in the cabin. In FIG. 1, the broken line represents only the ventilation outlet 20 at the right end of the vehicle. A projector for a HUD device is attached to the position P on the upper surface of the instrument panel 1. This projector prevents the defroster outlet 10 from extending to both sides in the vehicle width direction, and the defroster outlet 10 is provided only in a narrow range at the center in the vehicle width direction. A center display 30 is mounted at the center of the upper surface of the instrument panel 1, at a position closer to occupants (i.e., closer to the rear of the vehicle) than the defroster outlet 10 is. The center display 30 displays, for example, information of a car navigation system.

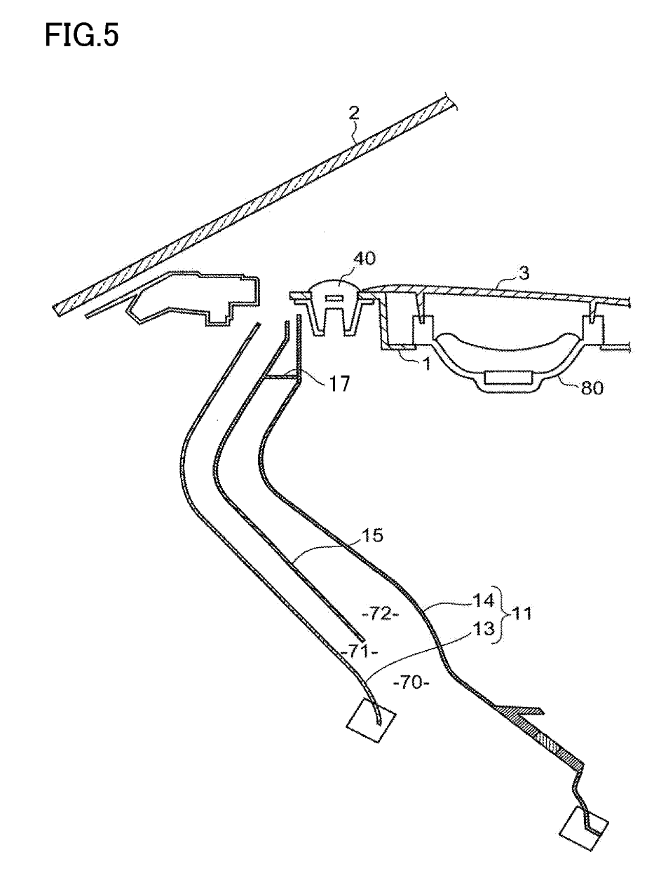

As shown in FIG. 2, a grille 12 is attached to the defroster outlet 10 to prevent foreign substances from entering a defroster duct 11. A sun sensor 40 is provided at the center of the defroster outlet 10 in the vehicle width direction at a position closer to the rear of the vehicle (see also FIG. 5). The sun sensor 40 detects the intensity of the sunlight (insolation) incident into the cabin. The insolation detected by the sun sensor 40 may be used, for example, for air conditioning.

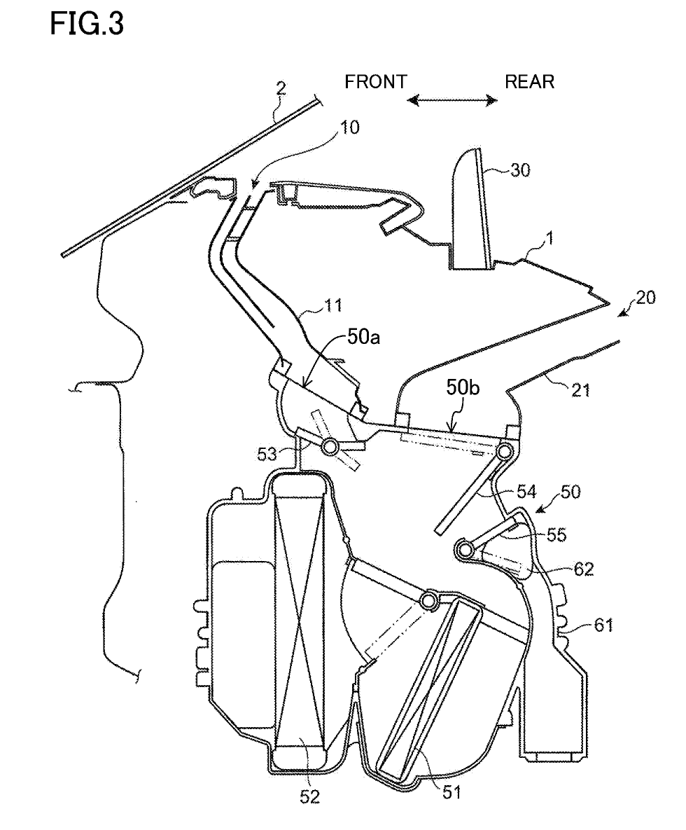

As shown in FIG. 3, an air conditioning unit 50 is arranged inside the instrument panel 1. The air conditioning unit 50 includes a heater 51 and an evaporator 52. The heater 51 heats air sent out of an air blowing unit (not shown). The evaporator 52 cools the air. The temperature or humidity of the air is controlled, and then the controlled (conditioned) air is sent outside the air conditioning unit 50.

The air conditioning unit 50 includes, at the front of its upper surface, a front sender 50a sending out conditioned air. The air conditioning unit 50 also includes, at the rear of its upper surface, a rear sender 50b sending out conditioned air. The defroster duct 11 is connected to the periphery of the front sender 50a of the air conditioning unit 50. The front sender 50a sends out conditioned air to the defroster duct 11. The front sender 50a is covered with a rear wall member 14 of the defroster duct 11, which will be described later. The conditioned air coming from the front sender 50a is sent out toward the rear wall member 14. On the other hand, a ventilation duct 21 is connected to the periphery of the rear sender 50b of the air conditioning unit 50. The rear sender 50b sends out conditioned air to the ventilation duct 21. The defroster and ventilation ducts 11 and 21 communicate with their outlets, namely, the defroster and ventilation outlets 10 and 20, respectively. The states of the air passages in the defroster and ventilation ducts 11 and 21 are switchable by a defroster damper 53 and a ventilation damper 54, respectively, in the air conditioning unit 50, so as to communicate or not to communicate with the inside of the air conditioning unit 50.

The air conditioning unit 50 is also connected to a front foot air duct 61 and a rear foot air duct 62 on its surface facing the rear of the vehicle. The front foot air duct 61 extends downward. The rear foot air duct 62 extends to feet of rear seats. The states of the air passages in the front and rear foot air ducts 61 and 62 are switchable by a foot air damper 55 in the air conditioning unit 50 so as to communicate or not to communicate with the inside of the air conditioning unit 50. Each of the dampers 53-55 has a shaft extending in the vehicle width direction. This shaft is rotatably supported at both its ends by sidewalls of the air conditioning unit 50 located on both sides in the vehicle width direction.

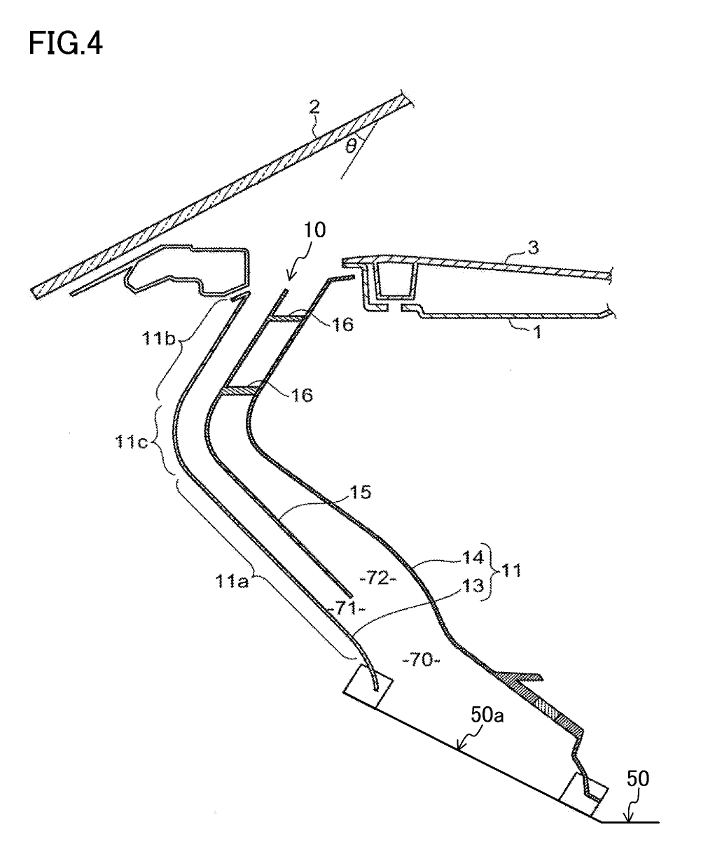

FIG. 4 is a cross-sectional view taken along the plane A-A of FIG. 2, and a partial enlarged view of FIG. 3. FIG. 5 is a cross-sectional view taken along the plane B-B of FIG. 2. The plane B-B passes through the middle of the defroster outlet 10 in the width direction, which agrees with the vehicle's centerline in the vehicle width direction. The plane A-A is slightly offset to the left side of the vehicle from the plane B-B. In FIGS. 4 and 5, a cover member 3 is provided above the instrument panel 1. As shown in FIG. 5, a loudspeaker 80 is provided in the upper portion of the instrument panel 1 at a position closer to the rear of the vehicle than the sun sensor 40 is. Description of the structure of the defroster duct 11 follows.

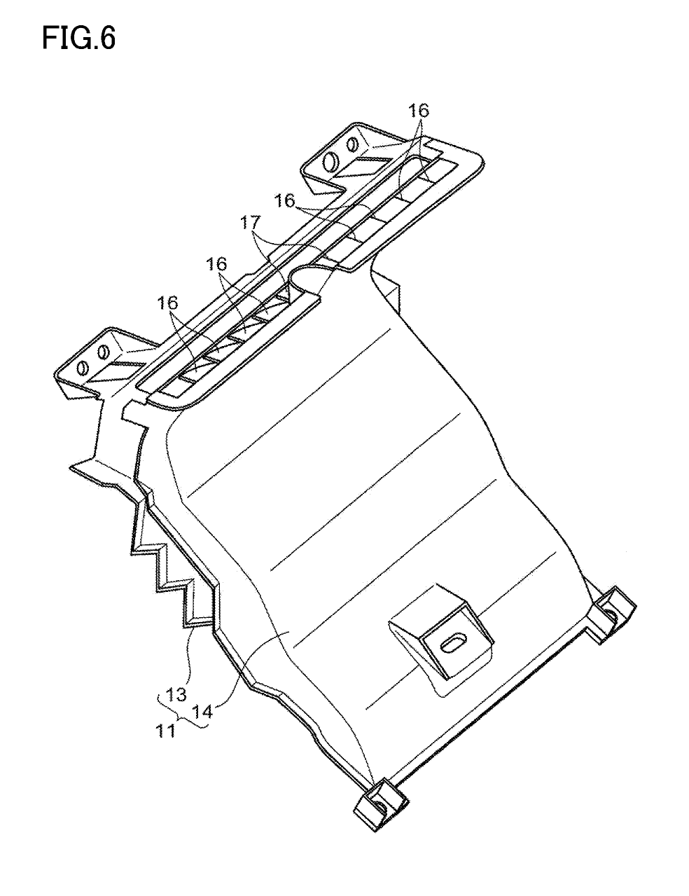

The defroster duct 11 has a flat shape (see FIG. 6). A portion of the defroster duct 11 located closer to the air conditioning unit 50 will be hereinafter referred to as an “upstream portion 11a,” its portion located closer to the defroster outlet 10 as a “downstream portion 11b,” and its portion curved and connecting the upstream and downstream portions 11a and 11b together as a “curved portion 11c.” The upstream portion 11a extends from the upstream end surface of the defroster duct 11, which is connected to the periphery of the front sender 50a of the air conditioning unit 50, so as to be inclined upward toward the front of the vehicle, and is then connected to the lower end of the curved portion 11c. The curved portion 11c curves with its vertical center protruding toward the front of the vehicle in a side view of the vehicle. The downstream portion 11b extends from the upper end of the curved portion 11c toward the windshield 2 so as to be inclined upward toward the rear of the vehicle. In as side view of the vehicle, the blown conditioned air preferably defines an angle (θ of FIG. 4) of about 30 degrees from the windshield 2.

The defroster duct 11 is comprised of a front wall member 13 located closer to the front of the vehicle, and a rear wall member 14 located closer to the rear of the vehicle. An air passage 70 in the defroster duct 11 defined between the front and rear wall members 13 and 14 is provided with a partition 15, which divides the air passage 70 in the vehicle longitudinal direction. The partition 15 extends from a point upstream of the curved portion 11c of the defroster duct 11 to the downstream end of the downstream portion 11b (i.e., to reach the defroster outlet 10 being the outlet of the duct 11). The partition 15 curves only at the curved portion 11b of the defroster duct 11 and forms a plane at the other portions. A plurality of deflecting ribs 16, which will be described later, stand on the inner curved surface of the partition 15, which faces the rear of the vehicle.

The air passage 70 includes a space 71, which is defined between the partition 15 and the front wall member 13, and located closer to the front of the vehicle. This space 71 functions as an air supply passage (hereinafter referred to as a “central air supply passage 71”) to distribute air to the center of the windshield 2 in the vehicle width direction. On the other hand, a space 72, which is defined between the partition 15 and the rear wall member 14, and located closer to the rear of the vehicle, functions as an air supply passage (hereinafter referred to as a “side air supply passage 72”) to distribute air to both the (right and left) sides of the windshield 2 in the vehicle width direction, by utilizing the deflecting ribs 16.

Suppose W1 represents the width of the side air supply passage 72 (i.e., the gap between the partition 15 and the rear wall member 14 as measured perpendicularly to the partition 15) at the point on the upstream portion 11a of the defroster duct 11. Also suppose each of W2 and W3 represents the width of the side air supply passage 72 (i.e., the gap between the partition 15 and the rear wall member 14 as measured perpendicularly to the partition 15) at two arbitrary points on the downstream portion 11b. Then, the relation among W1, W2, and W3 is expressed by W1>W2=W3. As shown in FIG. 5, the cross-sectional area of the side air supply passage 72 decreases at the center of the defroster duct 11 in the vehicle width direction near the outlet of the defroster duct 11. Optionally, the side air supply passage 72 may have a constant width in the upstream portion 11 a of the defroster duct 11.

As shown in FIG. 4, the side air supply passage 72 is adjacent to a portion of an inner surface of the duct 11, which faces a portion (i.e., the front sender 50a) of the air conditioning unit 50 sending conditioned air to defroster duct 11 in an air sending direction. That is, the side air supply passage 72 is provided for the rear wall member 14. The side air supply passage 72 is provided on the inner curved side of the curved portion 11c of the defroster duct 11. In addition, at a defroster duct upstream end of the partition 15, the side air supply passage 72 has a larger cross-sectional area than the central air supply passage 71 does. This structure makes the quantity of conditioned air introduced to the side air supply passage 72 larger than the quantity of air introduced to the central air supply passage 71. The cross-sectional area of the side air supply passage 72 gradually decreases from the upstream portion 11a to the curved portion 11c of the defroster duct 11. In this manner, the flow velocity of the conditioned air is increased in the upstream portion 11a.

In this specification, the cross-sectional area of each air passage represents the cross-sectional area of the portion through which the conditioned air actually passes. The cross-sectional area does not include, for example, the portion (i.e., above the V-shaped rib 17), in which a V-shaped rib 17 hinders passage of the conditioned air. The V-shaped rib 17 will be described later.

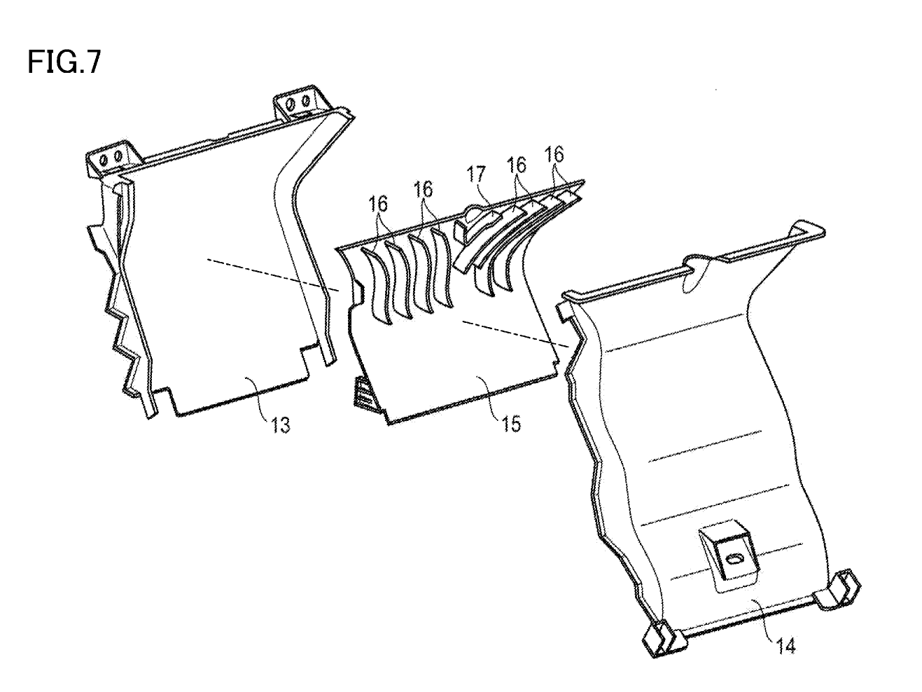

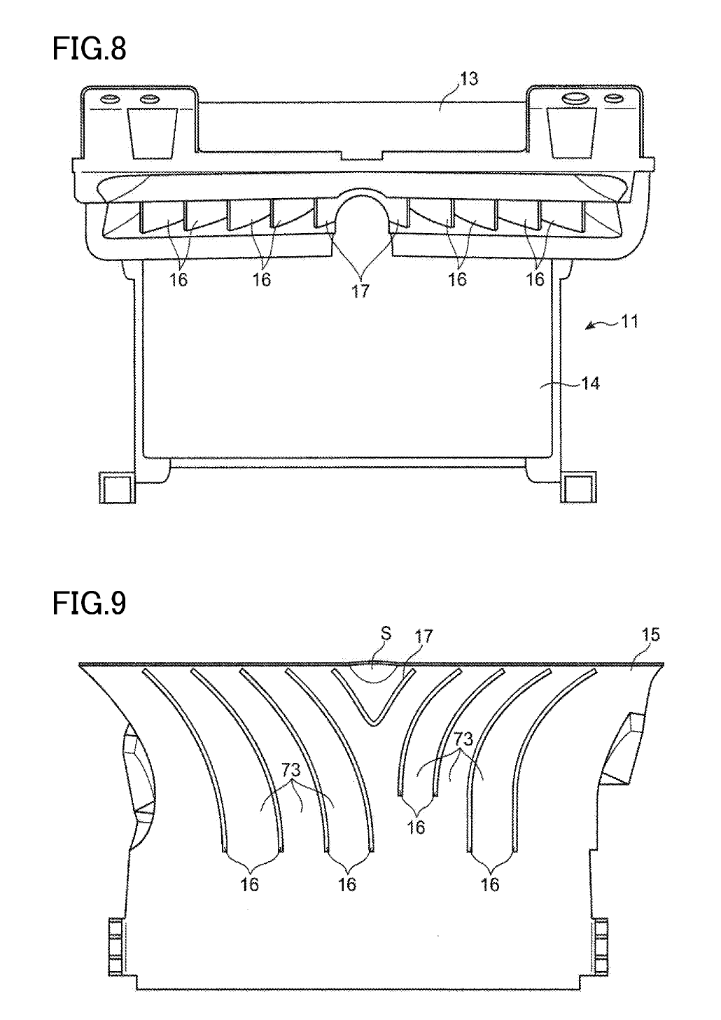

As shown in FIGS. 6-8, the partition 15 is interposed between the front and rear wall members 13 and 14, and integrally fixed to the front and rear wall members 13 and 14. The sizes of the front wall member 13, the rear wall member 14, and the partition 15, which constitute the defroster duct 11, as measured in the vehicle width direction (particularly at the downstream portion 11b) increases from upstream to downstream in the defroster duct 11. Thus, the sizes of the central and side air supply passages 71 and 72 as measured in the vehicle width direction also increase from upstream to downstream in the defroster duct 11.

As shown in FIG. 9, the deflecting ribs 16 are arranged in the vehicle width direction, on the surface of the partition 15 at the inner curved side (i.e., the surface facing the side air supply passage 72). The deflecting ribs 16 are arranged so as to deflect upward from its lower end toward the left or right side of the vehicle. Specifically, the deflecting ribs 16, which are located on the left side of the center of the partition 15 in the vehicle width direction, curve upward to the left side of the vehicle. On the other hand, the deflecting ribs 16, which are located on the right side of the center of the partition 15 in the vehicle width direction, curve upward to the right side. The deflecting ribs 16 are exemplary directing members that direct the conditioned air. This structure makes the quantity of conditioned air, which is blown out of the defroster outlet 10 after having passed through the side air supply passage 72, larger on both the right and left sides than at the center of the defroster outlet 10 in the vehicle width direction. The deflecting ribs 16 extend from points slightly upstream of the curved portion 11c of the defroster duct 11 to the defroster outlet 10. In the vehicle longitudinal direction, the deflecting ribs 16 extend from the partition 15 toward the rear wall member 14 to abut on the rear wall member 14. As a result, the side air supply passage 72 is divided into a plurality of sub-air passages 73 in the vehicle width direction. That is, the deflecting ribs 16 are provided so as to divide the side air supply passage 72 into the sub-air passages 73.

In order to increase the quantity of conditioned air introduced to the respective sub-air passages 73, and the flow velocity of the conditioned air passing through the sub-air passages 73, each sub-air passage 73 has a larger cross-sectional area at its upstream end than at its downstream end. In this illustrative embodiment, the sub-air passages 73 have the same cross-sectional area at the defroster outlet 10. However, the sub-air passages 73 may also be designed to have a cross-sectional area at the defroster outlet 10 increased toward either the right or left side of the vehicle such that the closer to the right or left end of the defroster outlet 10 is, the larger the quantity of conditioned air blown out through the defroster outlet 10 is.

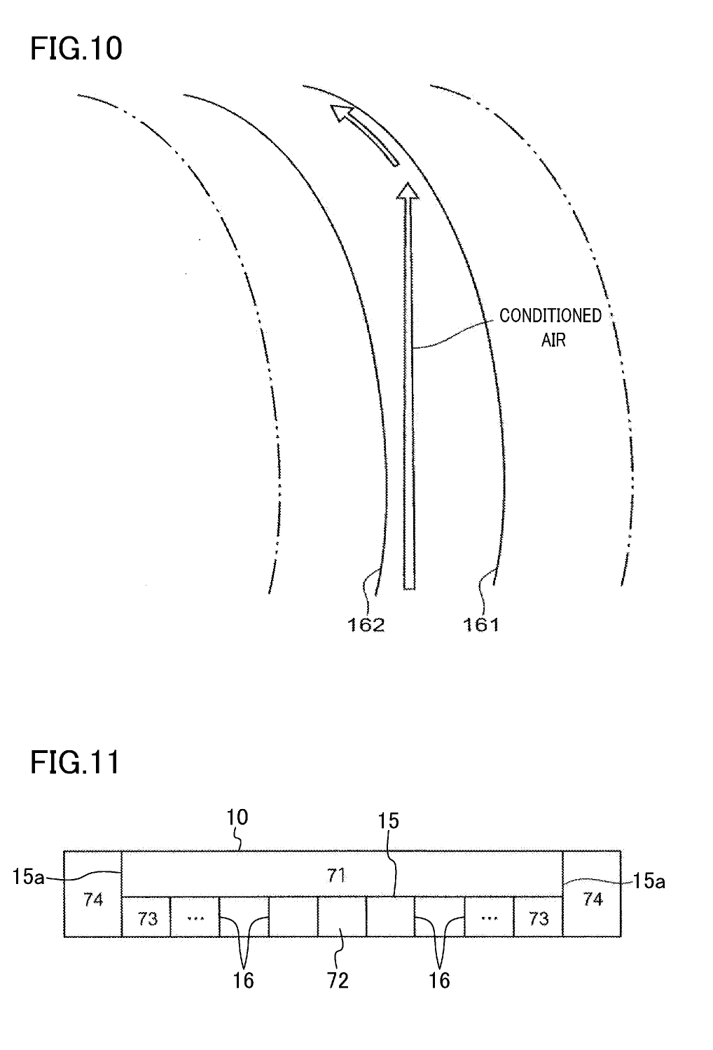

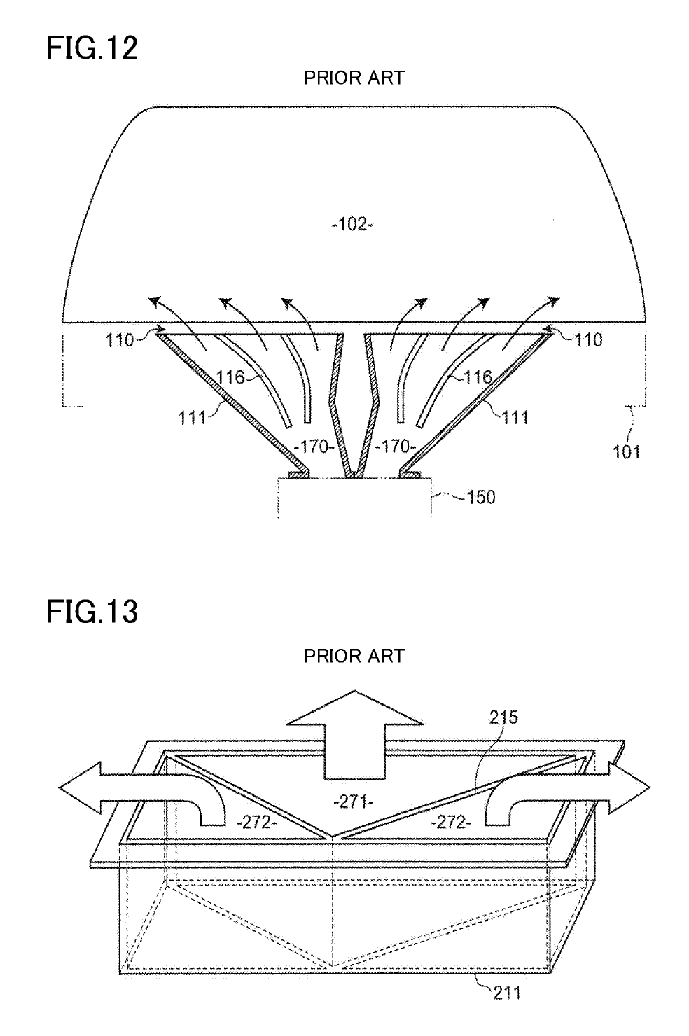

In this manner, the deflecting ribs 16 are provided such that a larger quantity of air is blown out of the defroster outlet 10 after having passed through the side air supply passage 72 on both the right and left sides than at the center of the defroster outlet 10 in the vehicle width direction. The deflection degrees of the deflecting ribs 16 in this illustrative embodiment are as shown in FIG. 9, and will be specifically described later with reference to FIG. 10. In FIG. 9, the deflecting ribs 16 are arranged horizontally asymmetrically with respect to the center of the partition 15 in the vehicle width direction to adjust the air blowing direction finely. The number or deflection degrees of the deflecting ribs 16 may be determined as appropriate depending on the shape or arrangement of the defroster duct 11.

A V-shaped rib 17, which has a V-shape as viewed in the vehicle longitudinal direction, stands at the downstream end of the side air supply passage 72 at the center in the vehicle width direction. This V-shaped rib 17 functions as an air blowing direction restricting member reducing the quantity of air blown out from the center of the defroster outlet 10 in the vehicle width direction. As well as the deflecting ribs 16, the V-shaped rib 17 also extends from the partition 15 toward the rear wall member 14 to abut on the rear wall member 14. No conditioned air flows above the V-shaped rib 17 (at the portion “S” and the space above the portion S in FIG. 9). In this space, the sun sensor 40 is arranged as an exemplary predetermined device.

Next, the function of a defroster structure according to this illustrative embodiment will be described.

The conditioned air introduced from the air conditioning unit 50 to the defroster duct 11 is distributed to the central and side air supply passages 71 and 72 defined by the partition 15. The conditioned air, which has passed through the central air supply passage 71, is blown out of the defroster duct 11 toward the center of the windshield 2 in the vehicle width direction. On the other hand, the conditioned air, which has passed through the side air supply passage 72, has its air blowing direction turned into a predetermined one by the deflecting and V-shaped ribs 16 and 17 and is blown out toward both the right and left sides of the windshield 2 in the vehicle width direction, while being distributed to both the right and left sides. The conditioned air, which has passed through the central and side air supply passages 71 and 72 and is blown out of the defroster outlet 10, abuts on the windshield 2 while forming a predetermined angle (θ in FIG. 4) in a side view of the vehicle.

FIG. 10 illustrates two arbitrary adjacent ones of the deflecting ribs 16. One of the two ribs 16 that is located closer to the center in the vehicle width direction will be hereinafter referred to as a “first deflecting rib 161.” The other rib located outside in the vehicle width direction will be hereinafter referred to as a “second deflecting rib 162.” The second deflecting rib 162 is located outside the first deflecting rib 161 in the vehicle width direction. The first deflecting rib 161 deflects such that a defroster duct downstream end of the first deflecting rib 161 is located outside a defroster duct upstream end of the second deflecting rib 162 in the vehicle width direction. Thus, as represented by the arrow in FIG. 10, the conditioned air introduced straight to the side air supply passage 72 is directed outward in the vehicle width direction (to the right or left side of the vehicle) along the first deflecting rib 161. As a result, the directivity of the conditioned air improves.

The V-shaped rib 17 is provided at the downstream end of the side air supply passage 72 at the center in the vehicle width direction. Thus, the conditioned air, which has passed through the side air supply passage 72, is not blown out from the center of the defroster outlet 10 in the vehicle width direction, but only from both the right and left sides. This allows for excellent air distribution over the entire windshield 2 in the vehicle width direction.

The partition 15 starts at the point upstream of the curved portion 11c of the defroster duct 11. The conditioned air introduced to the defroster duct 11 is thus distributed, in a rectified state, to the central and side air supply passages 71 and 72 before being disturbed by the curved portion 11c. As a result, a required quantity of conditioned air is readily taken into the side air supply passage 72. The conditioned air taken into the side air supply passage 72 passes through the curved portion 11c, and has its air blowing direction turned reliably into a predetermined one by the deflecting and V-shaped ribs 16 and 17, in the downstream portion 11b before reaching the defroster outlet 10. This allows for supplying a sufficient quantity of conditioned air to both the right and left ends, particularly to the lower end corners, of the windshield 2, thereby reliably preventing or reducing condensation over the entire windshield 2.

The present disclosure is not limited to the illustrative embodiment described above. Substitution may be made without departing from the scope of the present disclosure defined by the appended claims.

For example, in the illustrative embodiment, the space of the air passage 70 located closer to the front of the vehicle is supposed to be the central air supply passage 71, and the space located closer to the rear of the vehicle is supposed to the side air supply passage 72. This arrangement is employed to prevent the conditioned air, which is blown out after having passed through the central and side air supply passages 71 and 72, from interfering with each other, and to introduce a sufficient quantity of conditioned air from the air conditioning unit 50 into the side air supply passage 72. Conversely, however, the space of the air passage 70 closer to the front of the vehicle may be defined as a side air supply passage, and the space closer to the rear of the vehicle may be defined as a central air supply passage.

In the illustrative embodiment, the deflecting ribs 16 are supposed to abut on the rear wall member 14 to form the sub-air passages 73. Alternatively, the deflecting ribs 16 may extend from the partition 15 toward the rear wall member 14 to reach just the vicinity of the rear wall member 14 without abutting on the rear wall member 14. Even so, the deflecting ribs 16 improve the directivity of the conditioned air. Furthermore, the deflecting ribs 16 may extend from the rear wall member 14 toward the partition 15. In this case, the deflecting ribs 16 may or may not abut on the partition 15. Moreover, the V-shaped rib 17 may extend from the partition 15 toward the rear wall member 14, but does not have to abut on the rear wall member 14. Alternatively, the V-shaped rib 17 may extend from the rear wall member 14 toward the partition 15. In this case, the V-shaped rib 17 may or may not abut on the partition 15.

In the illustrative embodiment, the partition 15 divides the air passage 70 in the vehicle longitudinal direction throughout the entire width of the vehicle. However, as schematically shown as a variation in FIG. 11, for example, the partition 15 may divide the entire air passage 70 in the vehicle longitudinal direction but both the ends in the vehicle width direction. According to the structure of this variation, an air passage 74 formed at each end of the air passage 70 in the vehicle width direction functions as a side air supply passage. The air passages 74 and the central air supply passage 71 are defined by a front extension 15a, which is provided at each end of the partition 15 extending in the vehicle width direction and extends from this end toward the front of the vehicle. The air passages 74 increases the total opening area of the side air supply passages of the defroster outlet 10, thereby achieving the advantage of increasing the quantity of air supplied to the right and left side ends of the windshield 2.

Although only one partition 15 is provided in the illustrative embodiment described above, a plurality of partitions 15 may be provided. For example, if two partitions 15 are provided, the air passage 70 is divided into three spaces, namely, spaces at the front and rear of the vehicle and at the center between the two. Where two partitions 15 are provided, the space closer to the front of the vehicle is preferably a central air supply passage for the same reasons as in the illustrative embodiment, in which the space of the air passage 70 closer to the front of the vehicle is the central air supply passage 71, and the space closer to the rear of the vehicle is the side air supply passage 72. One of the central and rear spaces may be a side air supply passage for distributing air to one side of the windshield 2 in the vehicle width direction (e.g., the left side of the vehicle). The other may be a side air supply passage for distributing air to the other side of the windshield 2 in the vehicle width direction (e.g., the right side of the vehicle). The orientation of deflecting ribs provided in each side air supply passage may be adjusted according to the direction of the air distribution. This variation enables smooth control of the air distribution to both the sides of the windshield 2 in the vehicle width direction.

In the illustrative embodiments, only the side air supply passage 72 includes the deflecting ribs 16 as directing members, and the central air supply passage 71 does not include any directing member. Alternatively, the central air supply passage 71 may also include a directing member to adjust the directivity of the conditioned air finely.

The illustrative embodiments described above are mere example, and not intended to limit the scope of the present disclosure. The scope of the present disclosure is defined by the claims. Any modification or variation deemed to equivalent to the claims fall within the scope of the present disclosure.

What is claimed is:

1. A defroster structure for a vehicle, comprising:
a duct connected to an air conditioning unit, and guiding conditioned air sent out of the air conditioning unit to an outlet, the outlet being provided at a center of an upper surface of an instrument panel in a vehicle width direction along a lower end of a windshield, wherein
the duct includes
an upstream portion located closer to the air conditioning unit,
a downstream portion located closer to the outlet, and
a curved portion curved and connecting the upstream and downstream portions together,
an air passage in the duct has a partition dividing the air passage in a vehicle longitudinal direction into a central air supply passage and a side air supply passage,
the central air supply passage distributes air to a center of the windshield in the vehicle width direction,
the side air supply passage distributes air to right and left sides of the windshield in the vehicle width direction, and
the partition extends from a point upstream of the curved portion of the duct to the downstream portion.

2. The defroster structure of claim 1, wherein
at a duct upstream end of the partition, the side air supply passage has a larger cross-sectional area than the central air supply passage.

3. The defroster structure of claim 2, wherein
the cross-sectional area of the side air supply passage decreases from the upstream portion to the curved portion of the duct.

4. The defroster structure of claim 1, wherein
the side air supply passage is adjacent to a portion of an inner surface of the duct facing a portion of the air conditioning unit sending conditioned air to the duct in an air sending direction.

5. The defroster structure of claim 3, wherein
the side air supply passage is adjacent to a portion of an inner surface of the duct facing a portion of the air conditioning unit sending conditioned air to the duct in an air sending direction.

6. The defroster structure of claim 1, wherein
the side air supply passage is provided on an inner curved side of the curved portion of the duct.

7. The defroster structure of claim 3, wherein
the side air supply passage is provided on an inner curved side of the curved portion of the duct.

8. The defroster structure of claim 1, wherein
the central air supply passage is provided closer to a front of the vehicle, and
the side air supply passage is provided closer to a rear of the vehicle.

9. The defroster structure of claim 3, wherein
the central air supply passage is provided closer to a front of the vehicle, and
the side air supply passage is provided closer to a rear of the vehicle.

10. The defroster structure of claim 1, wherein
a size of the side air supply passage as measured in the vehicle width direction increases from upstream to downstream in the duct, and
the side air supply passage includes a directing member directing conditioned air such that a larger quantity of air passes through the side air supply passage and is blown out of the outlet on right and left sides than at a center of the outlet in the vehicle width direction.

11. The defroster structure of claim 10, wherein
the directing member divides the side air supply passage into a plurality of sub-air passages.

12. The defroster structure of claim 11, wherein
each of the sub-air passages has a larger cross-sectional area at an upstream end thereof than at a downstream end thereof.

13. The defroster structure of claim 10, wherein
the side air supply passage includes, as the directing member,
a first deflecting rib, and
a second deflecting rib located outside the first deflecting rib in the vehicle width direction, and
a duct downstream end of the first deflecting rib is located outside a duct upstream end of the second deflecting rib in the vehicle width direction.

14. The defroster structure of claim 12, wherein
the side air supply passage includes, as the directing member,
a first deflecting rib, and
a second deflecting rib located outside the first deflecting rib in the vehicle width direction, and
a duct downstream end of the first deflecting rib is located outside a duct upstream end of the second deflecting rib in the vehicle width direction.

15. The defroster structure of claim 2, wherein
the side air supply passage is adjacent to a portion of an inner surface of the duct facing a portion of the air conditioning unit sending conditioned air to the duct in an air sending direction,
the side air supply passage is provided on an inner curved side of the curved portion of the duct,
the central air supply passage is provided closer to a front of the vehicle, and
the side air supply passage is provided closer to a rear of the vehicle.

16. The defroster structure of claim 10, wherein
the side air supply passage includes an air blowing direction restricting member at a downstream end thereof, and
the air blowing direction restricting member reduces a quantity of conditioned air passing through the side air supply passage and blown out from the center of the outlet in the vehicle width direction.

17. The defroster structure of claim 12, wherein
the side air supply passage includes an air blowing direction restricting member at a downstream end thereof, and
the air blowing direction restricting member reduces a quantity of conditioned air passing through the side air supply passage and blown out from the center of the outlet in the vehicle width direction.

18. The defroster structure of claim 16, wherein
a predetermined device is provided above the air blowing direction restricting member.

19. A defroster structure for a vehicle, comprising:
a duct connected to an air conditioning unit, and guiding conditioned air sent out of the air conditioning unit to an outlet, the outlet being provided at a center of an upper surface of an instrument panel in a vehicle width direction along a lower end of a windshield, wherein
the duct includes
an upstream portion located closer to the air conditioning unit,
a downstream portion located closer to the outlet, and
a curved portion curved and connecting the upstream and downstream portions together,
an air passage in the duct has a partition dividing the air passage in a vehicle longitudinal direction into a central air supply passage and a side air supply passage,
the central air supply passage distributes air to a center of the windshield in the vehicle width direction,
the side air supply passage distributes air to right and left sides of the windshield in the vehicle width direction,
the partition extends from a point upstream of the curved portion of the duct to the downstream portion,
at a duct upstream end of the partition, the side air supply passage has a larger cross-sectional area than the central air supply passage,
the cross-sectional area of the side air supply passage decreases from the upstream portion to the curved portion of the duct,
the side air supply passage is adjacent to a portion of an inner surface of the duct facing a portion of the air conditioning unit sending conditioned air to the duct in an air sending direction,
the side air supply passage is provided on an inner curved side of the curved portion of the duct,
the central air supply passage is provided closer to a front of the vehicle, and
the side air supply passage is provided closer to a rear of the vehicle.

20. A defroster structure for a vehicle, comprising:
a duct connected to an air conditioning unit, and guiding conditioned air sent out of the air conditioning unit to an outlet, the outlet being provided at a center of an upper surface of an instrument panel in a vehicle width direction along a lower end of a windshield, wherein
an air passage in the duct has a partition dividing the air passage in a vehicle longitudinal direction into a central air supply passage and a side air supply passage,
the central air supply passage distributes air to a center of the windshield in the vehicle width direction,
the side air supply passage distributes air to right and left sides of the windshield in the vehicle width direction,
a size of the side air supply passage as measured in the vehicle width direction increases from upstream to downstream in the duct,
the side air supply passage includes a directing member directing conditioned air such that a larger quantity of air passes through the side air supply passage and is blown out of the outlet on right and left sides than at a center of the outlet in the vehicle width direction,
the directing member divides the side air supply passage into a plurality of sub-air passages,
each of the sub-air passages has a larger cross-sectional area at an upstream end thereof than at a downstream end thereof,
the side air supply passage includes, as the directing member,
a first deflecting rib, and
a second deflecting rib located outside the first deflecting rib in the vehicle width direction,
a duct downstream end of the first deflecting rib is located outside a duct upstream end of the second deflecting rib in the vehicle width direction,
the side air supply passage includes an air blowing direction restricting member at a downstream end thereof, and
the air blowing direction restricting member reduces the quantity of air passing through the side air supply passage and blown out from the center of the outlet in the vehicle width direction.
